(19) United States
(12) Patent Application Publication
(10) Pub. No.: US 2007/0093287 A1
(43) Pub. Date: Apr. 26, 2007

(54) Keno game with bonus

(76) Inventors: Kenneth Brunelle, Las Vegas, NV (US); Danny R. Piper, Las Vegas, NV (US)

Correspondence Address: Susan E. Money, 2300 E. Silverado Ranch Blvd. # 1015, Las Vegas, NV, 89183, US

(21) Appl. No.: 11/652,357

(22) Filed: Jan. 10, 2007

Related U.S. Application Data
(60) Provisional application No. 60/873,773, filed on Dec. 8, 2006.

(51) Int. Cl. A63F 13/00

(52) U.S. Cl. 463/19

(57) ABSTRACT

The present invention provides a game including a display defining a plurality of positions. A set of player symbols are selected from a set of playable symbols, preferably by a player. A bonus position is also selected from the plurality of positions defined by the display. The bonus position is also preferably selected by a player. A set of winning symbols are preferably randomly selected from the set of playable symbols and displayed on the display, with one winning symbol displayed in each of the plurality of positions. A bonus is awarded if the winning symbol displayed within the bonus position is among the set of player symbols. The symbols are preferably numbers. The winning symbols displayed within the bonus position and/or the bonus position may be accented on the display.

### CROSS-REFERENCE TO RELATED APPLICATIONS

This application claims the benefit and priority of U.S. Provisional Application No. 60/873,773 filed on Dec. 8, 2006, and entitled “Method of playing video keno with bonus award,” which is incorporated herein by reference in its entirety.

### FIELD OF THE INVENTION

The present invention is directed to a game of chance, and more particularly to a keno game having a bonus feature.

### BACKGROUND OF THE INVENTION

In a standard game of keno, a player chooses between one and ten numbers from the numbers 1-80. Keno may be played electronically on a video keno machine wherein players select numbers using touch-screen technology, or live, with players selecting numbers by making tickets. After a player selects numbers, twenty winning numbers are randomly selected from the field of eighty numbers. Weighted average paytables are used to award a payout based on the number of player numbers which matching the winning numbers. Typically, the paytables are based on the number of “spots” picked, or the number of player numbers selected. The more numbers that match, the higher the payout.

In a live keno game, typically the playable numbers (i.e., 1-80) are represented by eighty keno balls numbered 1 through 80. An air blower device circulates the balls within the device. The winning numbers are selected by randomly choosing twenty of the eighty balls. On a typical video keno machine, the winning numbers are displayed as “balls”, much like the winning numbers in the live keno game. The winning numbers enter a 2×10 grid as they are selected. In each game, there is a place on the screen or the game board where the winning numbers are displayed.

### SUMMARY OF THE INVENTION

The present invention provides a game including a display defining a plurality of positions. A set of player symbols are selected from a set of playable symbols, preferably by a player. A bonus position is also selected from the plurality of positions defined by the display. The bonus position is also preferably selected by a player. A set of winning symbols are preferably randomly selected from the set of playable symbols and displayed on the display, with one winning symbol displayed in each of the plurality of positions. A bonus is awarded if the winning symbol displayed within the bonus position is among the set of player symbols. The symbols are preferably numbers. The winning symbol displayed within the bonus position and/or the bonus position may be accented oil the display.

The present invention can be used with a video display or with a tangible, “live” display. As with traditional keno games, the player receives a payout if a predetermined number of the player symbols match the set of winning symbols. Preferably, the payout follows a pay table having a weighted probability based on the total number of player symbols selected. The bonus may be a multiplier of the payout, or it may be an award independent from the payout. When used with a traditional keno game, the set of playable symbols includes 80 symbols, the set of winning symbols includes 20 symbols, and the set of player symbols includes between 1 and 10 symbols. Preferably, as demonstrated, there are more symbols in the set of winning symbols than in the set of player symbols (e.g., 20 winning symbols vs. 1-10 player symbols).

In one aspect of the invention, a player selects a plurality of bonus positions, with the winning symbol displayed within each bonus position being compared to the set of player symbols to determine if a bonus is awarded. In this aspect of the invention, the bonus increases based on the total number of winning symbols displayed within bonus positions matching the set of player symbols. The plurality of positions may form a grid having rows and columns, with a player selecting a “bonus row” and/or a “bonus column” from the grid to select a plurality of bonus positions. Similarly, the plurality of positions may define a plurality of concentric circles, with the player designating at least one of the circles as a “bonus ring” to select a plurality of bonus positions.

The present invention also provides a method of playing a keno game. First, a set of playable numbers are defined. Next, a display defining a plurality of positions is provided. Next, a set of player numbers are selected from among the set of playable numbers, preferably by a player. A bonus position is also selected from among the plurality of positions defined by the display. A set of winning numbers is then chosen, preferably randomly, from the set of playable numbers. The winning numbers are displayed on the display with one winning number in each of the plurality of positions. The winning numbers displayed in the bonus positions are compared to the set of player numbers, with a bonus being awarded if any winning number displayed within a bonus position is among the set of player numbers.

### BRIEF DESCRIPTION OF THE DRAWING

The above features and advantages and other features and advantages of the invention are readily apparent from the following detailed description of the best or carrying out the invention when taken in connection with the accompanying drawings, wherein:

FIG. 1 is a schematic of a display according to the preferred embodiment of the present invention;

FIG. 2a is an alternative embodiment of a display according to the present invention after choosing winning numbers but before entering the winning numbers into a of positions defined by the display;

FIG. 2b is the embodiment of the display shown in FIG. 2a with the winning numbers entered into the plurality of positions; and

FIG. 3 is a flowchart presenting a method of playing a game according nt invention.

### DESCRIPTION OF THE PREFERRED EMBODIMENTS

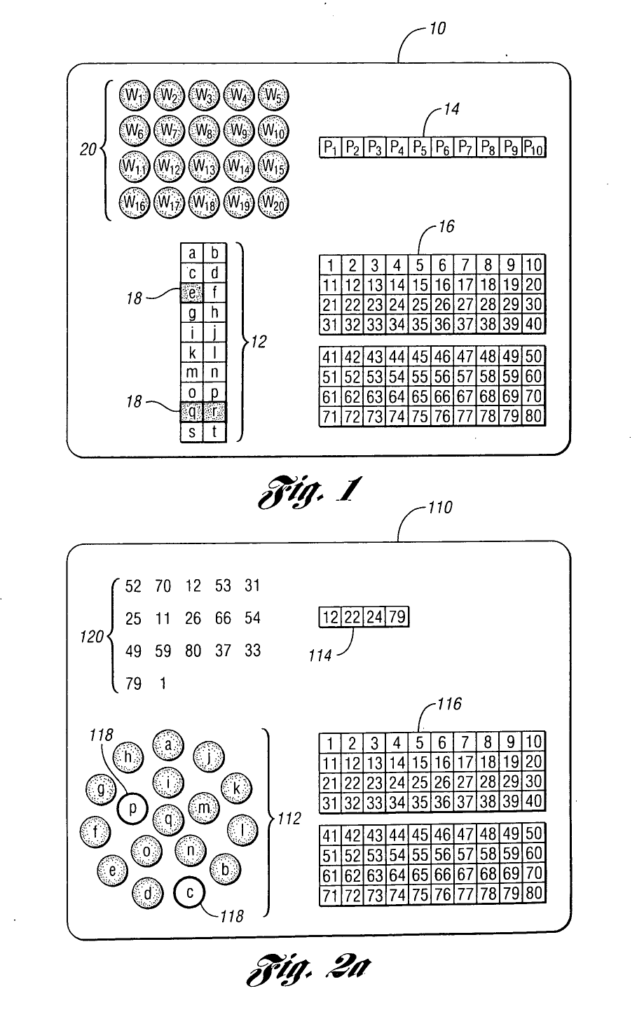

Referring to the drawings, wherein like numerals equal like parts, FIG. 1 is a schematic of a display 10 according to the preferred embodiment of the present invention. Particularly, the display 10 shows a video keno screen incorporating the present invention. The display 10 defines a plurality of winning positions 12, shown as a-t in a ×10 grid in FIG. 1. A set of player numbers 14, shown as p₁-p₁₀ in FIG. 1, are shown after having been selected from a set of playable numbers 16.

In a keno game according to the present invention, a player selects at least one bonus position 18 from among the plurality of winning positions 12. The bonus positions 18 selected for the game represented by FIG. 1, particularly winning positions e, q and r, are shown in boldface for clarity. The display 10 may accordingly accent the bonus positions. The bonus positions 18 are preferably selected by a player, but may be selected in some other manner without changing the inventive concept. The number of bonus positions 18 may depend on a variety of factors. By way of example, a player may be allowed to choose one bonus position 18 for every three player numbers 14 chosen. If the winning positions 12 are in a pattern, such as the 2×10 grid shown in FIG. 1, a player may be allowed to choose bonus positions by choosing a bonus portion of the pattern. For example, winning positions q and r have been designated as bonus positions 18 in FIG. 1L; it may be the case that q and r were chosen as bonus positions 18 by a player allowed to choose a bonus row. In any event, the inventive concept contemplates selecting at least one bonus position 18 from a plurality of winning positions 12.

A set of winning numbers 20 are preferably randomly selected from the set of playable numbers 16. Although the winning numbers 20, particularly w₁ through w₂₀, are not shown within the winning positions 12 in FIG. 1 for clarity, each winning position a-t displays one of the winning numbers 20. The winning numbers 20 may be placed within the winning positions 12 randomly or in a predetermined order. For instance, assume the winning numbers 20 are chosen in order from w₁ to w₂₀. It may be the case that w₁ is displayed in winning position s, w₂ is displayed in winning position q, . . . w₁₀ is displayed in winning position a, w₁₁ is displayed in winning position t, W₁₂ is displayed in winning position r, . . . and w₂₀ is displayed in winning position b. It may also be the case that the winning numbers 20 are randomly disbursed throughout the winning positions 12. The winning numbers 20 may be chosen simultaneously or in any manner of succession without changing the inventive concept.

Winning numbers 20 displayed within bonus positions 18 are compared to the player numbers 14. Referring to FIG. 1, then, if w₇ is displayed in winning position q, w₇ is compared with the set of player numbers 14 to determine whether a bonus is awarded. A bonus is awarded if at least one of the winning numbers 20 displayed within the bonus positions 18 match any of the player numbers 14. Thus, if w₇ matches any of the player numbers 14, a bonus would be awarded in the situation shown in FIG. 1. The invention contemplates increasing the bonus award based on the total number of winning numbers 20 displayed within bonus positions 18 which match player numbers 14. Thus, if a player “hits” two player numbers 14, i.e., if two of the player numbers 14 match winning numbers 20, and if those two “hits” are in bonus positions 18, the bonus award would preferably be larger than if the player had only one “hit” in a bonus position 18. The invention further contemplates a “jackpot”, or a significantly higher bonus award, if a predetermined number or player numbers 14 match winning numbers 20 in bonus positions 18. For example, if a player picks six player numbers 14, and all six of those “picks” match winning, numbers 20 displayed within bonus positions 18, that player may be awarded a jackpot.

Since FIG. 1 shows a typical video keno screen, the set of playable numbers 14 are 1 through 80 as indicated. Additionally, there are 20 winning positions, a-t, as discussed previously. The present invention can be used with an infinite combination of playable numbers and winning positions without changing the inventive concept. For instance, the playable numbers could be 110 through 167, with 10 winning positions instead of 20. Additionally, while keno games traditionally utilize numbers, the inventive concept contemplates the use of symbols other than numbers. For example, the playable numbers 12 could actually be different symbols, related or unrelated, such as a set of different fruits, or a set of different movie actors. To practice the present invention, it matters only that at least one winning position 12 be selected as a bonus position 18 before the winning symbols 20 are selected and placed within the winning positions 12.

As with traditional keno games, a payout is awarded if a predetermined number of the player numbers 14 is among the set of winning numbers 20. However, the inventive concept lies in awarding a bonus when winning numbers 20 are displayed within bonus positions 18. The bonus may be a multiplier for the payout, or it may be a separate award. It should also be noted that while the present invention is shown using a video display 10, the invention may be practiced using a tangible display, i.e., as a “live” game, without changing the inventive concept. For example, in a “live” game, the winning positions could be actual physical positions on a game surface. Since the winning numbers 20 only pay a player when the winning numbers 20 match the player numbers 14, the winning numbers 20 are in effect potential winning numbers, with a payout awarded when a predetermined number of player numbers 14 match winning numbers 20, and a bonus awarded when a predetermined number of player numbers 14 match winning numbers 20 displayed within bonus positions 18.

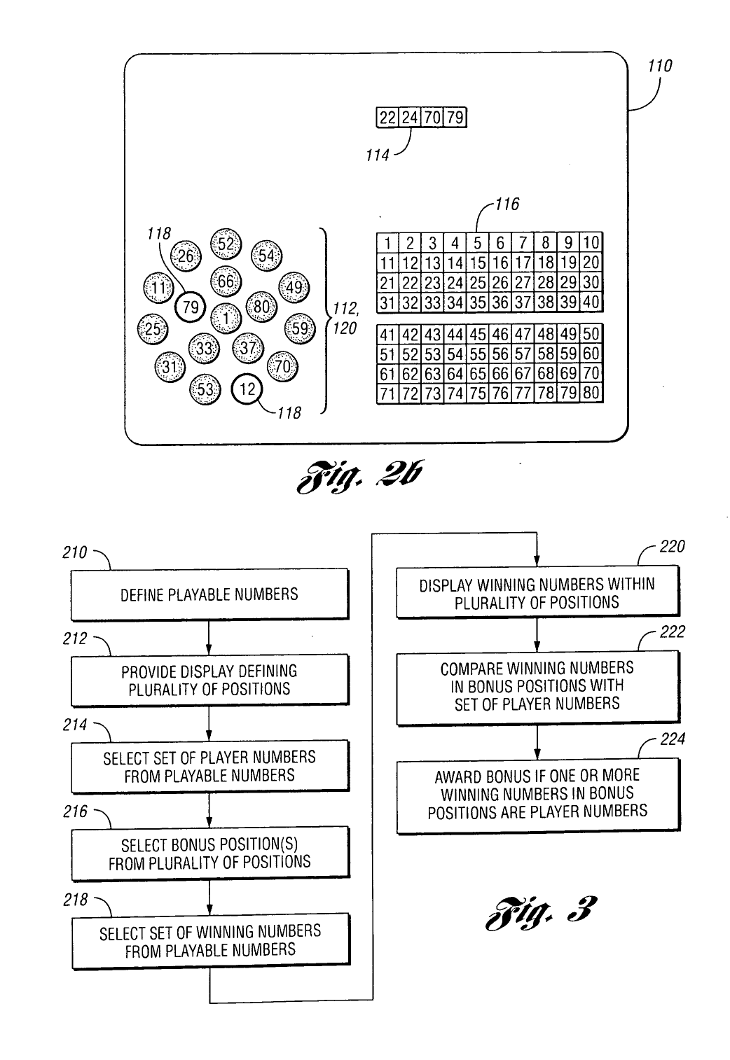

Referring to FIGS. 2a and 2b, an example keno game according to the present invention is illustrated. A display 110 shows 17 winning positions 112 arranged as two rings around a central winning position. As shown in FIGS. 2a and 2b, a set of playable numbers 116 includes 80 members, the numbers 1 through 80. Four player numbers 114 have been selected from the set of playable numbers 116, particularly 22, 24, 70 and 79. Two bonus positions 118 have been selected: from the outer ring, winning position c has been selected; and from the inner ring, winning position p has been selected. The bonus positions 118 are shown in boldface for clarity. Since there are 17 winning positions 112, the set of winning numbers 120 includes 17 members. The winning numbers 120 are shown at the top of FIG. 2a, and are shown in FIG. 2b displayed within the winning positions 112.

Assume the winning numbers 120 were chosen in the following order, and placed within the winning positions a-q consecutively: 52, 70, 12, 53, 31, 25, 11, 26, 66, 54, 49, 59, 80, 37, 33, 79 and 1. Winning numbers 120 displayed within bonus positions 118 are thus identifiable to be 12 and 79. Since 79, one of the winning numbers 120 displayed within a bonus position 118, matches one of the players numbers 114, a bonus will be awarded. Note also that two of the players numbers 114 match winning numbers 120: 70 and 79. According to the present invention, a payout is awarded if a predetermined number of the player numbers 114 are among the set of winning numbers 120. Preferably, the payout follows a pay table having a weighted probability based on the size of the set of players numbers 114; i.e., the larger the set of players numbers 114, the higher the payout. Thus a payout could be awarded based on a player hitting two numbers of the four numbers he picked. The bonus award can be separate from the payout, or it can be awarded in conjunction therewith. By way of example, the bonus award can be a multiplier of the payout, a predetermined amount, an amount based on weighted probabilities, or any other amount or other type of bonus within the scope of the present invention.

Turning now to FIG. 3, a flowchart schematically depicts a method of playing a game according to the present invention. First, a set of playable numbers is defined in box 210. Next, a display is provided defining a plurality of positions in box 212. A set of player numbers are selected from the playable numbers in box 214, while in box 216, at least one bonus position is selected from among the plurality of positions defined by the display. Preferably, boxes 214 and 216 are completed by a player, but the player numbers and the bonus position(s) may be otherwise selected within the scope of the present invention. In box 218, a set of winning numbers are selected from the set of playable numbers. In box 220, the set of winning numbers are displayed on the display with one winning number displayed in each of the plurality of positions defined by the display. Winning numbers displayed within bonus positions are compared to the set of player numbers, with box 224 awarding a bonus if one or more of the winning numbers displayed within bonus positions are among the set of player numbers. The winning numbers displayed within bonus positions and/or the bonus positions themselves may be highlighted on the display, i.e., a video screen or a live game board, for example.

While the best modes for carrying out the invention have been described in detail, it is to be understood that the terminology used is intended to be in the nature of words and description rather than of limitation. Those familiar with the art to which this invention relates will recognize that many modifications of the present invention are possible in light of the above teachings. As one example, the inventive concept could easily be networked between two or more machines, with the jackpot increasing across the network until it is awarded. It is, therefore, to be understood that within the scope of the appended claims, the invention may be practiced in a substantially equivalent way other than as specifically described herein.

1. A game comprising:
a display defining a plurality of positions;
a set of playable numbers;
a set of player numbers selected by a player from said set of playable numbers;
a bonus position selected from among said plurality of positions, said bonus position preferably selected by said player; and
a set of winning numbers preferably randomly selected from said set of playable numbers and displayed on said display such that one of said set of winning numbers is displayed in each of said plurality of positions;
wherein said player is awarded a bonus if said one of said set of winning numbers displayed within said bonus position is among said set of player numbers.

2. The game of claim 1, wherein said display is a video display.

3. The game of claim 1, wherein said display is a tangible display.

4. The came of claim 1, wherein said player receives a payout if a predetermined number of said set of player numbers are present among said set of winning numbers.

5. The game of claim 4, wherein said bonus is a multiplier for said payout.

6. The game of claim 1, wherein said player selects a plurality of bonus positions, said player being awarded a bonus if said winning number displayed within at least one of said plurality of bonus positions is among said set of player numbers.

7. The game of claim 6, wherein said bonus award increases based on the total number of said winning numbers displayed within said plurality of bonus positions matching, said set of player numbers.

8. The game of claim 6, wherein said plurality of positions define a grid having rows and columns, and wherein said player selects said plurality of bonus positions by designating at least one of a bonus row and a bonus column from among said rows and columns.

9. The game of claim 6, wherein said plurality of positions define a plurality of concentric circles, and wherein said player selects said plurality of bonus positions by designating, at least one of said plurality of concentric circles as a bonus circle.

10. The game of claim 1, wherein at least one of said bonus position and said one of said winning numbers displayed within said bonus position are accented on said display.

11. The game of claim 1, wherein said set of player numbers is smaller than said set of winning numbers.

12. A method of playing a keno game comprising:
a) defining a set of playable numbers;
b) providing a display defining a plurality of positions;
c) selecting a set of player numbers from said set of playable numbers;
d) selecting a bonus position from among said plurality of positions;
e) selecting a set of winning numbers from said set of playable numbers;
f) displaying said set of winning numbers on said display, wherein one of said set of winning numbers is displayed in each of said plurality of positions;
g) comparing said one of said set of winning numbers displayed within said bonus position to said set of player numbers; and
h) awarding a bonus if said one of said set of winning numbers displayed within said bonus position is among said set of player numbers.

13. The method of claim 12, wherein a player selects said set of player numbers.

14. The method of claim 12, wherein a player selects said bonus position.

15. The method of claim 12, wherein at least one of said one of said set of winning numbers displayed within said bonus position and said bonus position are accented on said display.

16. A game comprising:
a display defining a plurality of positions;
a set of playable symbols;
a set of player symbols selected from said set of playable symbols;
a bonus position selected from among said plurality of positions; and
a set of winning symbols preferably randomly selected from said set of playable symbols and displayed on said display such that one of said set of winning symbols is displayed in each of said plurality of positions;
wherein a payout is awarded if a predetermined number of said set of player symbols is among said set of winning symbols, and wherein a bonus is awarded if said one of said set of winning symbols displayed within said bonus position matches at least one of said set of player symbols.

17. The game of claim 16, wherein said playable symbols are numbers.

18. The game of claim 16, wherein said payout follows a pay table having a weighted probability based on the total number of symbols in said set of player symbols.

19. The game of claim 16, wherein said bonus award is a multiplier for said payout.

20. The game of claim 16, wherein said set of playable symbols includes 80 symbols, said set of winning symbols includes 20 symbols, and said set of player symbols includes between 1 and 10 symbols.
